(19) United States
(12) Patent Application Publication
(10) Pub. No.: US 2014/0110186 A1
(43) Pub. Date: Apr. 24, 2014

(54) MANEUVERING DRIVE WITH ADDITIONAL BRAKE MODULE

(71) Applicant: TRUMA GERAETETECHNIK GMBH & CO. KG, Putzbrunn (DE)

(72) Inventors: Steve AEMISEGGER, Muenchen (DE); Daniel GUMPP, Neusaess (DE); Jochen MUELLER, Moosach (DE); Tobias SCHMID, Erding (DE); Klaus MUESSLER, Egenburg (DE); Ana Maria FERNANDEZ, Muenchen (DE); Joerg MUELLER, Egmating (DE); Oliver SCHAURER, Oberding (DE); Mario MOEHRING, Gammelsdorf (DE); Mathias VENSCHOTT, Muenchen (DE); Stefan THIEL, Rosenheim (DE); Kamil ZAWADSKI, Haar (DE)

(73) Assignee: TRUMA GERAETETECHNIK GMBH & CO. KG, Putzbrunn (DE)

(21) Appl. No.: 14/058,962

(22) Filed: Oct. 21, 2013

(30) Foreign Application Priority Data
Oct. 22, 2012 (DE) 20 2012 010 074.2

(51) Int. Cl. B60L 7/24; B60S 9/00

(52) U.S. Cl. CPC B60L 7/24; B60S 9/00
USPC 180/65.31

(57) ABSTRACT

A maneuvering drive (24, 30) for a trailer (10) has a central unit (30) and at least two drive units (24) associated with wheels (16) of the trailer (10), each drive unit (24) including an electric drive motor (26) having a mechanical brake (40) associated therewith, an additional brake module (50) being provided which allows an additional braking effect of the drive units (24) to be generated in addition to the mechanical brake (40).

The present invention relates to a maneuvering drive for a trailer.

This trailer may be, for example, a travel trailer, a boat trailer, a horse trailer, a market trailer or the like, which is typically towed by a tractor or towing vehicle. For a travel trailer, in most cases a passenger car serves as the towing vehicle. In order to bring the trailer to its final position, for example on a campground, it is usually unhitched from the towing vehicle and pushed to its final position by hand. But this often involves major efforts since, as the requirements on the comfort of such travel trailers increase, the weight thereof also increases.

To make maneuvering easier, trailers may be equipped with maneuvering drives. A maneuvering drive is an auxiliary drive which in most cases has a drive unit with an electric motor for each wheel of the trailer. The electric motors are supplied with electrical energy by a battery in the trailer and may be coupled to the wheels of the trailer to drive them and maneuver the trailer in this way.

Each drive unit is provided with a mechanical brake in order to ensure that the trailer will not start moving unintentionally when the maneuvering drive is in an activated condition, for example when it is parked on a slope. In the initial condition, in particular with the maneuvering drive switched off, the brake is in a closed position. To release the brake, it has to be opened actively, for example by energizing a coil which can adjust a braking element to an open position by means of a lifting armature.

The object of the invention consists in further developing a maneuvering drive for a trailer to the effect that an even higher operational safety is obtained.

To achieve this object, according to the invention provision is made for a maneuvering drive for a trailer, including a central unit and at least two drive units associated with wheels of the trailer, each drive unit including an electric drive motor having a mechanical brake associated therewith, an additional brake module being provided which allows an additional braking effect of the drive units to be generated in addition to the mechanical brake. The invention is based on the fundamental idea of realizing an electronic/electric brake additionally to the mechanical brake. Such a brake can be implemented with comparatively little additional effort since no additional mechanical components are required.

According to a preferred embodiment of the invention, provision is made that the additional brake module seeks to actively control the speed of the drive motor to 0 rpm. This involves the opposite procedure to that of driving the wheels of the trailer; when the central unit or one of the drive units detects that the drive motors of the drive units rotate although the mechanical brake is activated, the additional brake module attempts to control the drive motors to rotate in a direction contrary to the direction of rotation, so that the rotor of the drive motor will ultimately stop.

According to a further configuration of the invention, provision is made for a wake-up module which is adapted to activate the central unit or the respective drive unit when it is supplied with electrical energy. The electrical energy may more particularly be provided by the drive motors which act as generators when they are driven by the wheels of the trailer. The wake-up module then allows the central unit or the corresponding drive units to take various countermeasures against an unintentional rolling away of the trailer. For example, an acoustic signal may be produced, or a remote control associated with the central unit may be activated at which likewise a warning is produced.

According to a preferred embodiment of the invention, provision is made that the electrical energy generated in generator mode of the drive motors is made use of for supplying the central unit or the corresponding drive unit, for the latter to control the drive motors to a speed of 0 rpm. Therefore, when the maneuvering drive (and thus the central unit) is switched off and the trailer starts moving unintentionally, in this embodiment the electric energy generated by the drive motors is made use of to automatically “start up” the central unit or the corresponding drive unit, for the latter to counteract the rolling away of the trailer by actively controlling the speed of the drive motors to 0 rpm. This results in the energy supply of the central unit or of the drive unit breaking down again because the drive motors no longer produce any energy whatsoever when the trailer is stationary. Should the trailer then start to move again, the central unit or the corresponding drive unit will be started up again and the braking process begins once again. As a result, altogether this results in a pulsating braking behavior by which the rolling away of the trailer can be substantially decelerated, so that the operator can take countermeasures.

According to one configuration of the invention, a short-circuit switch is provided by which the drive unit can short-circuit the drive windings of the drive motors. An additional braking effect can be produced in this way as well, since a short-circuited drive motor provides a certain braking effect which, however, will decrease as the speed decreases.

Preferably, provision is made here that the short-circuit switch short-circuits the drive windings of the drive motor with the central unit switched off and the drive unit switched off. Similarly to the mechanical brake, here the short-circuit switch automatically acts when the maneuvering drive is in the switched-off condition. However, the braking action of the short-circuit switch will not begin until the trailer has started to move and the rotors of the drive motors rotate.

The invention will now be described below with reference to an embodiment which is illustrated in the accompanying drawings, in which:

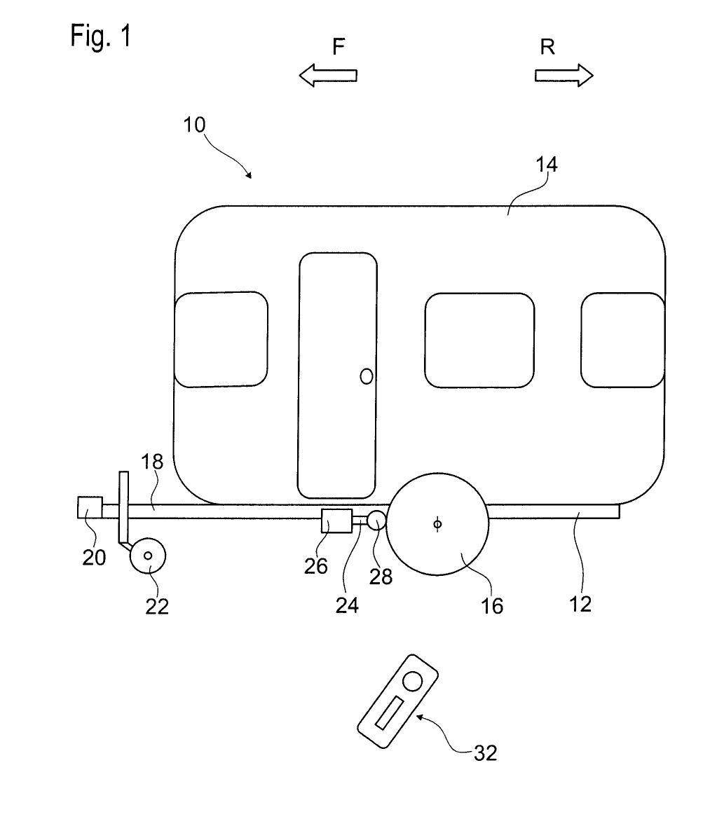

FIG. 1 shows a schematic side view of a trailer with a maneuvering drive; and

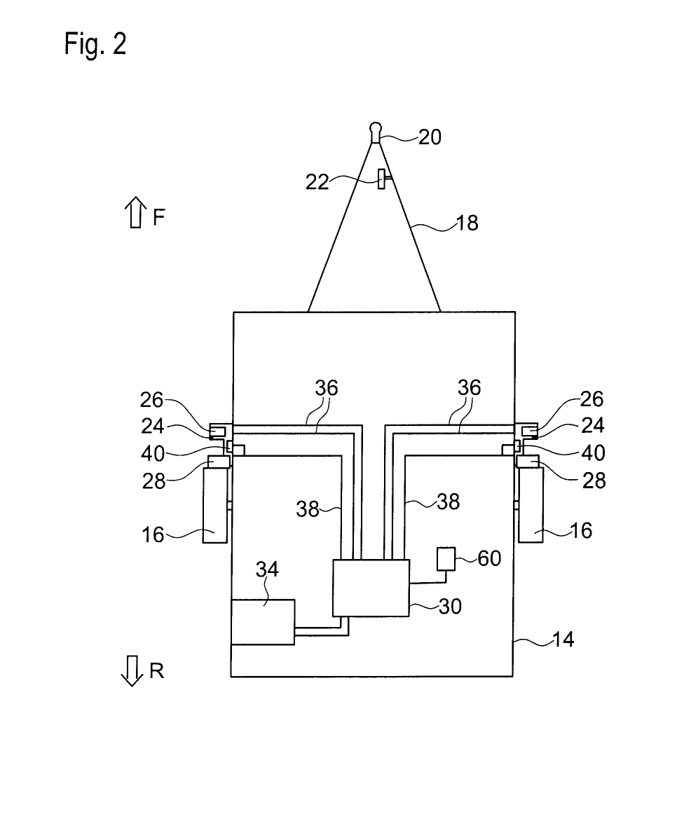

FIG. 2 shows a schematic plan view of the trailer of FIG. 1.

FIGS. 1 and 2 schematically show a trailer 10 (here a travel trailer) which includes a frame 12 to which a superstructure 14 is mounted. Further provided are a pair of wheels 16, a drawbar 18 and a coupling 20. The coupling 20 can be used for hitching the trailer 10 to a towing vehicle. Mounted to the drawbar 18 is an auxiliary wheel 22 which serves to support the trailer 10 in the unhitched condition.

Each wheel 16 of the trailer 10 has a drive unit 24 associated therewith. Each drive unit 24 includes a drive motor 26 which is typically in the form of an electric motor, as well as a drive roller 28 adapted to be driven by the drive motor 26. The drive roller 28 can be caused to engage with the associated wheel 16 of the trailer 10.

Further provision is made for a central unit 30 which serves as a central controller for the drive units 24 and is also responsible for the communication with an operator who may, for example, specify a straight ahead motion or a cornering motion, for example via a remote control 32 shown schematically in FIG. 1.

Furthermore provided in the trailer 10 is a voltage source 34 by means of which the central unit 30 and the drive units 24 can be supplied with electrical energy. The voltage source may be a power supply unit which is connected to an external power outlet, or an energy storage device on board the trailer. In this case, the energy storage device 34 typically is an accumulator, colloquially also often referred to as a battery. Here the drive motors 26 are connected to the central unit via connecting lines 36. Further, at least one control line 38 is provided for each drive unit, the control line extending from the central unit 30 to each drive unit 24.

The drive units 24 and the central unit 30 together form a maneuvering drive which can be used for shifting the trailer 10. For this purpose, the drive rollers 28 are caused to engage the wheels 16 of the trailer, so that they drive the wheels 16 when the drive motors 26 rotate. This is basically known from the prior art.

A single-axle trailer is shown here as an exemplary embodiment. Accordingly, the trailer 10 includes two wheels 16 each of which has a drive unit 24 associated with it. Basically, the same maneuvering drive can also be made use of in a two-axle trailer. Still a total of only two drive units may be used here, so that one driven wheel and one non-driven wheel are provided on each side of the trailer, or else two drive units may be employed on each side of the trailer, so that each wheel of the trailer can be driven.

Each drive unit 24 is provided with a mechanical brake 40 which may act, for example, directly on the shaft of the rotor of the drive motor 26. The mechanical brake is configured to automatically assume a closed condition. To release it, it has to be actively controlled. This is effected by means of the central unit 30 which releases the brakes 40 before the drive motors 26 are actuated, and closes the brakes 40 again when the drive motors 26 are no longer actuated.

The central unit 30 is provided with an additional brake module 50 which may be used for producing an additional braking effect of the drive units 24.

Part of the additional brake module 50 is a short-circuit switch 52 which automatically short-circuits the drive windings of the drive motors in the non- activated condition. That is, if an attempt is made to rotate the drive motors 26 with the central unit 30 in the switched-off condition, for example because the trailer 10 was parked on a slope and the downgrade force is so large that the wheels 16 can drive the drive motors 26 via the drive rollers 28, the drive motors 26 generate a braking effect by self-induction, the braking effect being the greater the higher the rotational speed of the drive motors 26.

The additional brake module 50 furthermore includes a wake-up module 54 which automatically starts up the central unit 30 from a condition switched off by the operator when it is detected that a voltage is applied to the connecting lines 36. This voltage is produced when the drive motors 26 run in a generator mode, that is, are driven from outside, as is the case when the trailer 10 starts moving unintentionally. In this case, the wake-up module 54 provides for the central unit 30 to be placed in a condition ready for operation at least to such an extent that a brake module 56 can be activated the function of which resides in actively controlling the speed of the drive motors 26 to 0 rpm. The energy necessary for this comes from the generator operation of the drive motors 26. By the brake module 56 seeking to control the speed of the drive motors to 0 rpm, a braking effect is produced which counteracts the rolling of the trailer. This generates a further braking effect beyond the braking effect of the mechanical brake 40.

As soon as the brake module 56 is successful in its efforts to control the speed of the drive motors 26 to 0 rpm, the energy supply by the electric drive motors 26 also breaks down again. This leads to the central unit 30 switching itself off again. Thereby, the drive windings of the drive motors 26 are also short-circuited again by the short-circuit switch 52.

If, in this condition, the force acting on the trailer 10 from outside continues to be so large that it is larger than the holding force generated by the mechanical brakes 40, the trailer 10 will slowly start moving again. At first, this movement is counteracted by the braking torque of the short-circuited drive motors 26 (beyond the braking effect of the mechanical brake 40). As soon as the electrical energy produced by the drive motors 26 during rolling exceeds a particular threshold, the wake-up module 54 will respond again, so that the central unit 30 becomes active again. As a result, the trailer 10 will roll at a greatly decelerated rate, the motion being composed of an acceleration phase, a deceleration phase, and a standstill phase, and so on.

Based on the additional braking effect provided by the central unit 30 through electric means, the trailer 10 will roll so slowly that an operator has the possibility to intervene.

According to a further development of the invention, provision may be made for an energy storage device in the central unit 30, for example in the form of a capacitor which is charged in the generator mode of the drive motors 26. In this way, the energy supply of the electric drive unit can be maintained for a certain period of time after the central unit 30 has actively controlled the drive motors 26 to a speed of 0 and thereby the generator effect of the drive motors has broken down.

Provision may also be made for an additional function that is integrated in the wake-up module 54 and produces a warning signal, for example an acoustic signal. In this way, the attention of an operator of the trailer or of other persons nearby may be drawn to the fact that there is a critical condition. It is also possible to activate the remote control 32 and to generate a warning signal there, for example an acoustic signal or a vibrating alert.

According to an alternative (not illustrated), each of the drive units 24 may be provided with an additional brake module 50. In this case, each of the drive units 24 will independently detect if it is supplied with power which does not come from the central unit 30, but from its drive motor. The countermeasures then initiated correspond to the countermeasures triggered by the central unit as discussed above.

A difference of the alternative configuration including a respective additional brake module for each drive unit consists in that the central unit 30 has to actuate and open the short-circuit switch 52 of each drive unit when the drive motors 26 are activated.

1. A maneuvering drive for a trailer, comprising a central unit and at least two drive units associated with wheels of the trailer, each drive unit including an electric drive motor having a mechanical brake associated therewith, an additional brake module being provided which allows an additional braking effect of the drive units to be generated in addition to the mechanical brake.

2. The maneuvering drive according to claim 1, characterized in that the additional brake module seeks to actively control the speed of the drive motor to 0 rpm.

3. The maneuvering drive according to claim 1, characterized in that the central unit or the corresponding drive unit includes a wake-up module which is adapted to activate the central unit or the drive unit when it is supplied with electrical energy.

4. The maneuvering drive according to claim 3, characterized in that the electrical energy generated in generator mode of the drive motors is made use of for supplying the central unit or the drive unit, for the latter to control the drive motors to a speed of 0 rpm.

5. The maneuvering drive according to claim 1, characterized in that a short-circuit switch is provided by which the drive windings of the drive motors can be short-circuited.

6. The maneuvering drive according to claim 5, characterized in that the short-circuit switch short-circuits the drive windings of the drive motor with the central unit switched off or with the drive unit switched off.

7. The maneuvering drive according to claim 5, characterized in that the short-circuit switch is arranged in the drive unit.

8. The maneuvering drive according to claim 1, characterized in that the additional brake module is arranged in the drive unit.

9. The maneuvering drive according to claim 6, characterized in that the short-circuit switch is arranged in the drive unit.
